(19) United States
(12) Patent Application Publication
(10) Pub. No.: US 2013/0052433 A1
(43) Pub. Date: Feb. 28, 2013

(54) COMPOSITIONS FOR LOW K, LOW TEMPERATURE CO-FIRED COMPOSITE (LTCC) TAPES AND LOW SHRINKAGE, MULTI-LAYER LTCC STRUCTURES FORMED THEREFROM

(71) Applicants: KUMARAN MANIKANTAN NAIR, HEAD OF THE HARBOR, NY (US); MARK FREDERICK MCCOMBS, CLAYTON, NC (US); STEPHEN C. BEERS, GRANVILLE SUMMIT, PA (US)

(72) Inventors: KUMARAN MANIKANTAN NAIR, HEAD OF THE HARBOR, NY (US); MARK FREDERICK MCCOMBS, CLAYTON, NC (US); STEPHEN C. BEERS, GRANVILLE SUMMIT, PA (US)

(73) Assignee: E I DU PONT DE NEMOURS AND COMPANY, Wilmington, DE (US)

(21) Appl. No.: 13/596,706

(22) Filed: Aug. 28, 2012

Related U.S. Application Data
(60) Provisional application No. 61/528,647, filed on Aug. 29, 2011.

(51) Int. Cl. C08L 33/08; C08L 33/10; B32B 7/02; C08K 3/22

(52) U.S. Cl. 428/212; 524/430

(57) ABSTRACT

Novel compositions for LTCC green tapes having low K values and low shrinkage and composite laminates of ten to twenty layers or more of green tapes together with conventional LTCC green tapes.

### FIELD OF THE INVENTION

The invention relates to novel compositions for making LTCC green tapes having low K values and low shrinkage, being able to tailor those low K values, and the use of at least two of such Low K, low shrinkage LTCC green tapes to make composite laminates of ten to twenty layers or more of green tapes together with conventional LTCC green tapes having shrinkage values of 7% to 8%, wherein the composite laminate exhibits a shrinkage on the order of 1% to 1.25% in a two mil configuration.

### TECHNICAL BACKGROUND OF THE INVENTION

### LTCC Generally

An interconnect circuit board is a physical realization of electronic circuits or subsystems made from a number of extremely small circuit elements that are electrically and mechanically interconnected. It is frequently desirable to combine these diverse type electronic components in an arrangement so that they can be physically isolated and mounted adjacent to one another in a single compact package and electrically connected to each other and/or to common connections extending from the package.

Complex electronic circuits generally require that the circuit be constructed of several layers of conductors separated by insulating dielectric layers. The conductive layers are interconnected between levels by electrically conductive pathways, called vias, through a dielectric layer. Such a multilayer structure allows a circuit to be more compact.

Typically, a LTCC tape is formed by casting a slurry of inorganic solids, organic solids and a fugitive solvent on a removable polymeric film. The slurry consists of glass powder(s) and ceramic oxide filler materials and an organic based resin-solvent system (medium) formulated and processed to a fluid containing dispersed, suspended solids. The tape is made by coating the surface of a removable polymeric film with the slurry so as to form a uniform thickness and width of coating.

In all subsequent discussion it is understood that the use of the term tape layer or dielectric layer implies the presence of metallizations both surface conductor and interconnecting via fills which are cofired with the ceramic tape. In a like manner the term laminate or composite implies a collection of metallized tape layers that have been pressed together to form a single entity.

### Challenges of LTCC for Dimensional Stability, Shrinkage

The use of a ceramic-based green tape to make low temperature co-fired ceramic (LTCC) multilayer circuits was disclosed in U.S. Pat. No. 4,654,095 to Steinberg. The co-fired, free sintering process offered many advantages over previous technologies. However, when larger circuits were needed, the variation of firing shrinkage along the planar or x,y direction proved too broad to meet the needs. Given the reduced sizes of the current generation of surface mount components, the shrinkage tolerance (reproducibility of x,y shrinkage) has proved too great to permit the useful manufacture of LTCC laminates much larger than 6″ by 6″. This upper limit continues to be challenged today by the need for greater circuit density as each generation of new circuits and packages evolves. In turn this translates into ever-smaller component sizes and thereby into smaller geometry's including narrower conductor lines and spaces and smaller vias on finer pitches in the tape. All of this requires a much lower shrinkage tolerance than could be provided practically by the free sintering of LTCC laminates.

A method for reducing x,y shrinkage during firing of green ceramic bodies in which a release-layer, which becomes porous during firing, is placed upon the ceramic body and the assemblage is fired while maintaining pressure on the assemblage normal to the body surface was disclosed in U.S. Pat. No. 5,085,720 to Mikeska. This method used to, make LTCC multilayer circuits provided a significant advantage over Steinberg, as a reduction x,y shrinkage was obtained through the pressure assisted method. An improved co-fired LTCC process was developed and is disclosed in U.S. Pat. No. 5,254,191 to Mikeska. This process, referred to as PLAS, an acronym for pressure-less assisted sintering, placed a ceramic-based release tape layer on the two major external surfaces of a green LTCC laminate. The release tape controls shrinkage during the firing process. Since it allows the fired dimension of circuit features to be more predictable the process represents a great improvement in the fired shrinkage tolerance.

In a more recent invention, U.S. patent application 60/385,697, from which commonly assigned U.S. Pat. No. 7,147,736 claims priority, the teachings of constrained sintering are extended to include the use of a non-fugitive, non-removable, non-sacrificial or non-release, internal self-constraining tape. The fired laminate comprises layers of a primary dielectric tape which define the bulk properties of the final ceramic body and one or more layers of a secondary or self-constraining tape. The purpose of the latter is to constrain the sintering of the primary tape so that the net shrinkage in the x,y direction is zero. This process is referred to as a self-constraining pressure-less assisted sintering process and the acronym SCPLAS is applied. The self-constraining tape is placed in strategic locations within the structure and remains part of the structure after co-firing is completed. There is no restriction on the placement of the self-constraining tape other than that z-axis symmetry is preserved.

Commonly assigned U.S. Pat. No. 7,175,724 describes camber problems associated with standard SCPLAS technology and states that the consequence of preserving z-axis symmetry is a severely bowed or cambered circuit.

### Embedded Passives

The introduction of dielectric layers with a higher dielectric constant (k) than the bulk dielectric material can produce localized enhanced capacitor capability when suitably terminated with a conductor material. This is commonly referred to as a buried or embedded passive structure and is a robust and cost-effective alternative to the use of standard, externally applied, surface mount components such as multilayer capacitors (MLC).

Commonly assigned U.S. Pat. No. 7,175,724 describes the use of symmetry as a solution, namely, to balance the asymmetrical and functional part of the structure with dummy, non functioning compensating layers but states that it does not alleviate all of the disadvantages of that solution to the challenges of building LTCC structures having embedded passive functionality. Other solutions are discussed and proposed.

There is a need in LTCC technology to have tape compositions with dimensional stability and low shrinkage.

There is a need in LTCC technology to have multiple layers of tapes, in laminate form, the individual layers having different dielectric constants, which can be fired as a laminate and exhibit low shrinkage and overall dimensional stability.

There is a need in LTCC technology to be able to tailor the dielectric constant of an LTCC layer or layers while preserving the processing properties of low shrinkage and overall dimensional stability described above. There is also a need to build laminates from such tapes which may be fired and exhibit low shrinkage and overall dimensional stability.

### SUMMARY OF THE INVENTION

The invention provides LTCC technology with tape compositions with dimensional stability and low shrinkage.

The invention provides LTCC technology with multiple layers of tapes, in laminate form, the individual layers having different dielectric constants, which can be fired as a laminate and exhibit low shrinkage and overall dimensional stability.

The invention provides LTCC technology with the ability to tailor the dielectric constant of an LTCC layer or layers while preserving the processing properties of low shrinkage and overall dimensional stability described above. The invention also provides LTCC technology with laminates from such tapes which may be fired and exhibit low shrinkage and overall dimensional stability.

### Tape Embodiment A

A green tape composition comprising, based on solids:
(a) 25-40 weight % glass composition, based on a total weight of (a) and (b), and either (x) consisting essentially of or (y) comprising, based on mole percent, (i) 46-57.96% B₂O₃, (ii) a glass network former selected from the group consisting of 0.5-8.5% P₂O₅, 1.72-5.00% SiO₂, and mixtures of P₂O₅ and SiO₂ wherein the combined mole % of said mixture of P₂O₅ and SiO₂ is 3.44-8.39%, (iii) 20-50% CaO, (iv) 2-15% Ln₂O₃ where Ln is selected from the group consisting of rare earth elements and mixtures thereof; (v) 0-6% Ml₂O where Ml is selected from the group consisting of alkali elements; and (vi) 0-10% Al₂O₃, wherein said glass composition is a ceramic-filled, devitrified glass composition, wherein said glass composition flows prior to crystallization;
(b) 60-75 weight % silica refractory oxide, based on a total weight of (a) and (b), both (a) and (b) dispersed in a solution of
(c) organic polymeric binder;
   wherein said green tape, after firing, has a dK between 3.5 and 4.0 and a loss tangent of less than 0.004.

### Tape Embodiment B

A green tape composition comprising, based on solids:
(a) 30-55 weight % glass composition, based on a total weight of (a) and (b), and either (x) consisting essentially of or (y) comprising, based on mole percent, (i) 46-57.96% B₂O₃, (ii) a glass network former selected from the group consisting of 0.5-8.5% P₂O₅, 1.72-5.00% SiO₂, and mixtures of P₂O₅ and SiO₂ wherein the combined mole % of said mixture of P₂O₅ and SiO₂ is 3.44-8.39%, (iii) 20-50% CaO, (iv) 2-15% Ln₂O₃ where Ln is selected from the group consisting of rare earth elements and mixtures thereof; (v) 0-6% Ml₂O where Ml is selected from the group consisting of alkali elements; and (vi) 0-10% Al₂O₃, wherein said glass composition is a ceramic-filled, devitrified glass composition, wherein said glass composition flows prior to crystallization;
(b) 45-70 weight % refractory oxide, based on a total weight of (a) and (b), comprising silica and alumina in a SiO₂:Al₂O₃ weight ratio from between about 2:1 to about 1:1, both (a) and (b) dispersed in a solution of
(c) organic polymeric binder;
   wherein said green tape, after firing, has a dK between 4.5 and 5.4 and a loss tangent of between 0.003 and 0.005.

### Tape Embodiment C

A green tape composition comprising, based on solids:
(a) 38-42 weight % glass composition, based on a total weight of (a) and (b), and either (x) consisting essentially of or (y) comprising, based on mole percent, (i) 46-57.96% B₂O₃, (ii) a glass network former selected from the group consisting of 0.5-8.5% P₂O₅, 1.72-5.00% SiO₂, and mixtures of P₂O₅ and SiO₂ wherein the combined mole % of said mixture of P₂O₅ and SiO₂ is 3.44-8.39%, (iii) 20-50% CaO, (iv) 2-15% Ln₂O₃ where Ln is selected from the group consisting of rare earth elements and mixtures thereof; (v) 0-6% Ml₂O where Ml is selected from the group consisting of alkali elements; and (vi) 0-10% Al₂O₃, wherein said glass composition is a ceramic-filled, devitrified glass composition, wherein said glass composition flows prior to crystallization;
(b) 58-62 weight % refractory oxide, based on a total weight of (a) and (b), comprising silica and alumina, wherein said silica is less than about 5.0 wt % and more than about 2.0 wt %, based on a total weight of (a) and (b), both (a) and (b) dispersed in a solution of
(c) organic polymeric binder;
   wherein said green tape, after firing, has a dK greater than 5.4 and less than 6.0 and a loss tangent of less than 0.003.

### Tape Embodiment D

A green tape composition comprising, based on solids:
(a) 25-40 weight % glass composition, based on a total weight of (a) and (b), and either (x) consisting essentially of or (y) comprising, based on mole percent, 50-67% B₂O₃; 20-50% CaO; 2-15% Ln₂O₃ where Ln is selected from the group consisting of rare earth elements and mixtures thereof; 0-6% Ml₂O where Ml is selected from the group consisting of alkali elements; and 0-10% Al₂O₃, with the proviso that the composition is water millable;
(b) 60-75 weight % silica refractory oxide, based on a total weight of (a) and (b), both (a) and (b) dispersed in a solution of
(c) organic polymeric binder;
   wherein said green tape, after firing, has a dK between 3.5 and 4.0 and a loss tangent of less than 0.004.

### Tape Embodiment E

A green tape composition comprising, based on solids:
(a) 30-55 weight % glass composition, based on a total weight of (a) and (b), and either (x) consisting essentially of or (y) comprising, based on mole percent, 50-67% B₂O₃; 20-50% CaO; 2-15% Ln₂O₃ where Ln is selected from the group consisting of rare earth elements and mixtures thereof; 0-6% Ml₂O where Ml is selected from the group consisting of alkali elements; and 0-10% Al₂O₃, with the proviso that the composition is water millable;
(b) 45-70 weight % refractory oxide, based on a total weight of (a) and (b), comprising silica and alumina in a SiO₂:Al₂O₃ weight ratio from between about 2:1 to about 1:1, both (a) and (b) dispersed in a solution of
(c) organic polymeric binder;
   wherein said green tape, after firing, has a dK between 4.5 and 5.4 and a loss tangent of between 0.003 and 0.005.

### Tape Embodiment F

A green tape composition comprising, based on solids:
(a) 38-42 weight % glass composition, based on a total weight of (a) and (b), and either (x) consisting essentially of or (y) comprising, based on mole percent, 50-67% B₂O₃; 20-50% CaO; 2-15% Ln₂O₃ where Ln is selected from the group consisting of rare earth elements and mixtures thereof; 0-6% Ml₂O where Ml is selected from the group consisting of alkali elements; and 0-10% Al₂O₃, with the proviso that the composition is water millable;
(b) 58-62 weight % refractory oxide, based on a total weight of (a) and (b), comprising silica and alumina, wherein said silica is less than about 5.0 wt % and more than about 2.0 wt %, based on a total weight of (a) and (b), both (a) and (b) dispersed in a solution of
(c) organic polymeric binder;
   wherein said green tape, after firing, has a dK greater than 5.4 and less than 6.0 and a loss tangent of less than 0.003.

### BRIEF DESCRIPTION OF THE DRAWINGS

FIG. 1 illustrates an electron micrograph of the composite laminate

### DETAILED DESCRIPTION OF THE INVENTION

As discussed in U.S. Pat. No. 7,687,417, incorporated by reference herein in its entirety, it has been observed that during the firing of an LTCC circuit laminate, the glass softens and crystallization initiates. As the temperature and/or time increases, more of the crystal species grow from the glass melt; resulting in crystals surrounded by a low viscosity “remnant glass”. At the firing temperature, this low viscosity “remnant glass” may react with the conductor composition causing an increase in the conductor resistivity. In extreme cases, the conductor lines dissipate within the fired film causing shorting, lack of electrical connectivity, reliability degradation, etc. This is particularly true for applications requiring narrow lines and spaces between conductor lines. Furthermore, newer LTCC circuits require the use of tape having a thickness on the order of 0.1 mm-0.3 mm and tape laminates of 20 or more layers. Processing steps of such thick laminates require a long heating profile of 30 hours or more. Such a long heating profile increases the interaction between the low viscosity “remnant glass” and conductor components resulting in increased conductor property degradation. In order to reduce conductor property degradation and improve the reliability of the circuit, the viscosity of the “remnant glass” may be increased by adding “glass network formers” such as SiO₂ and/or P₂O₅.

Significant and lengthy disclosure and discussion is provided in U.S. Pat. No. 7,687,417 contrasting the invention therein with that of commonly assigned U.S. Pat. No. 6,147,019 to Donohue incorporated herein by reference in its entirety.

Quite surprisingly, the inventors have discovered that either of the glass formulations disclosed in U.S. Pat. No. 7,687,417 (Tape Embodiments A, B & C) or the glass formulations disclosed in U.S. Pat. No. 6,147,019 to Donohue (Tape Embodiments D, E & F) may be used in the compositions in accordance with the invention. These glasses may be used alone in the tape composition (consisting essentially of) or they may be used together with other glasses (comprising) so long as the benefit of the invention is obtained as discussed herein. Without wishing to be bound by any theory or hypothesis, it is believed that there exists a “wetting angle” of the remnant glass component of a tape composition in accordance with the invention such that, if the wetting angle is sufficient, the particles of filler in the tape will be sufficiently coated or “wet” by the remnant glass during processing. This allows for the low porosity, low K, high mechanical strength and low shrinkage in accordance with the fired tapes of the invention.

The measurement of dielectric constant, K and dielectric loss (tangent delta) has been performed for the glasses indicated in. These measurements were performed using a (non-metallized) split cavity method in a range of frequency from 3.3 GHz to 16 GHz. A reference to the measurement method is given in “Full-Wave Analysis of a Split-Cylinder Resonator for Nondestructive Permittivity Measurements” by Michael Janezic published in IEEE Transactions on Microwave Theory and Techniques, Vol 47, No. 10, October 1999.

### Glass Preparation Procedures

The glasses were melted in platinum crucibles at a temperature in the range of 1350-1450° C. The batch materials were oxide forms with the exception of lithium carbonate, sodium carbonate and calcium carbonate. The phosphorous pentoxide was added in the form of a pre-reacted phosphate compound, such as Ca₂P₂O₇, Na₃P₃O₉, LiPO₃, or BPO₄. The glass was melted for 0.5-1 hour, stirred, and quenched. The glass may be quenched in water or by metal roller. The glass was then ball milled in water to a 5-7 micron powder. The glass slurry was screened through a 325-mesh screen. The slurry was dried then milled again to a final size of about 1-3 micron D50. The dried glass powder was then ready to be used in the tape formulation to make a tape.

Ceramic fillers (refractory oxide(s)) such as Al₂O₃, ZrO₂, SiO₂, TiO₂ or mixtures thereof may be added to the castable dielectric composition in amounts as disclosed in the embodiments and the following examples. Depending on the type of filler, different crystalline phases are expected to form after firing. The ceramic particles limit flow of the glass by acting as a physical barrier. They also inhibit sintering of the glass and thus facilitate better burnout of the organics. Other fillers, a-quartz, CaZrO₃, mullite, cordierite, forsterite, zircon, zirconia, BaTiO₃, CaTiO₃, MgTiO₃, amorphous silica or mixtures thereof may be used to modify tape performance and characteristics.

In embodiments of the invention, the amount of filler, type of filler and physical characteristics of the filler will influence the shrinkage of the fired green tape. Tape shrinkage may also be adjusted to controlled levels by the use of a multi-modal particle size distribution optimized to reduce shrinkage by increasing filler packing density.

The slurry and/or tape composition may further comprise 0-5 weight % Cu₂O, based on solids.

In the formulation of tape compositions, the amount of glass relative to the amount of ceramic material is important. A filler composition wt % range, subject to the compositional makeup in accordance with the different embodiments of the invention, and in amounts as disclosed in the embodiments and the following examples has been demonstrated to provide the surprising and unexpected results in accordance with the invention. Within the desirable glass to filler ratio, it will be apparent that, during firing, the filler phase will become saturated with liquid glass.

For the purpose of obtaining higher densification of the composition upon firing, it is important that the inorganic solids have small particle sizes. In particular, substantially all of the particles should not exceed 15 μm and preferably not exceed 10 μm. Subject to these maximum size limitations, it is preferred that at least 50% of the particles, both glass and ceramic filler, be greater than 1 μm and less than 6 μm.

The organic medium in which the glass and ceramic inorganic solids are dispersed is comprised of an organic polymeric binder which is dissolved in a volatile organic solvent and, optionally, other dissolved materials such as plasticizers, release agents, dispersing agents, stripping agents, antifoaming agents, stabilizing agents and wetting agents.

To obtain better binding efficiency, it is preferred to use at least 5% wt. polymer binder for 90% wt. solids (which includes glass and ceramic filler), based on total composition. However, it is more preferred to use no more than 30% wt. polymer binder and other low volatility modifiers such as plasticizer and a minimum of 70% inorganic solids. Within these limits, it is desirable to use the least possible amount of binder and other low volatility organic modifiers, in order to reduce the amount of organics which must be removed by pyrolysis, and to obtain better particle packing which facilitates full densification upon firing.

In the past, various polymeric materials have been employed as the binder for green tapes, e.g., poly(vinyl butyral), poly(vinyl acetate), poly(vinyl alcohol), cellulosic polymers such as methyl cellulose, ethyl cellulose, hydroxyethyl cellulose, methylhydroxyethyl cellulose, atactic polypropylene, polyethylene, silicon polymers such as poly(methyl siloxane), poly(methylphenyl siloxane), polystyrene, butadiene/styrene copolymer, polystyrene, poly(vinyl pyrollidone), polyamides, high molecular weight polyethers, copolymers of ethylene oxide and propylene oxide, polyacrylamides, and various acrylic polymers such as sodium polyacrylate, poly(lower alkyl acrylates), poly(lower alkyl methacrylates) and various copolymers and multipolymers of lower alkyl acrylates and methacrylates. Copolymers of ethyl methacrylate and methyl acrylate and terpolymers of ethyl acrylate, methyl methacrylate and methacrylic acid have been previously used as binders for slip casting materials.

U.S. Pat. No. 4,536,535 to Usala, issued Aug. 20, 1985, has disclosed an organic binder which is a mixture of compatible multipolymers of 0-100% wt. C.sub.18 alkyl methacrylate, 100-0% wt. C.sub.1-8 alkyl acrylate and 0-5% wt. ethylenically unsaturated carboxylic acid of amine. Because the above polymers can be used in minimum quantity with a maximum quantity of dielectric solids, they are preferably selected to produce the dielectric compositions of this invention. For this reason, the disclosure of the above-referred Usala application is incorporated by reference herein.

Frequently, the polymeric binder will also contain a small amount, relative to the binder polymer, of a plasticizer that serves to lower the glass transition temperature (Tg) of the binder polymer. The choice of plasticizers, of course, is determined primarily by the polymer that needs to be modified. Among the plasticizers which have been used in various binder systems are diethyl phthalate, dibutyl phthalate, dioctyl phthalate, butyl benzyl phthalate, alkyl phosphates, polyalkylene glycols, glycerol, poly(ethylene oxides), hydroxyethylated alkyl phenol, dialkyldithiophosphonate and poly(isobutylene). Of these, butyl benzyl phthalate is most frequently used in acrylic polymer systems because it can be used effectively in relatively small concentrations.

The solvent component of the casting solution is chosen so as to obtain complete dissolution of the polymer and sufficiently high volatility to enable the solvent to be evaporated from the dispersion by the application of relatively low levels of heat at atmospheric pressure. In addition, the solvent must boil well below the boiling point or the decomposition temperature of any other additives contained in the organic medium. Thus, solvents having atmospheric boiling points below 150° C. are used most frequently. Such solvents include acetone, xylene, methanol, ethanol, isopropanol, methyl ethyl ketone, ethyl acetate, 1,1,1-trichloroethane, tetrachloroethylene, amyl acetate, 2,2,4-triethyl pentanediol-1,3-monoisobutyrate, toluene, methylene chloride and fluorocarbons. Individual solvents mentioned above may not completely dissolve the binder polymers. Yet, when blended with other solvent(s), they function satisfactorily. This is well within the skill of those in the art. A particularly preferred solvent is ethyl acetate since it avoids the use of environmentally hazardous chlorocarbons.

In addition to the solvent and polymer, a plasticizer is used to prevent tape cracking and provide wider latitude of as-coated tape handling ability such as blanking, printing, and lamination. A preferred plasticizer is BENZOFLEX® 400 manufactured by Rohm and Haas Co., which is a polypropylene glycol dibenzoate.

### Application

A green tape is formed by casting a thin layer of a slurry dispersion of the glass, ceramic filler, polymeric binder and solvent(s) as described above onto a flexible substrate, heating the cast layer to remove the volatile solvent. This forms a solvent-free tape layer. The tape is then blanked into sheets or collected in a roll form. The green tape is typically used as a dielectric or insulating material for multilayer electronic circuits. A sheet of green tape is blanked with registration holes in each corner to a size somewhat larger than the actual dimensions of the circuit. To connect various layers of the multilayer circuit, via holes are formed in the green tape. This is typically done by mechanical punching. However, a sharply focused laser or other method(s) can be used to volatilize and form via holes in the green tape. Typical via hole sizes range from 0.1 to 6.4 mm. The interconnections between layers are formed by filling the via holes with a thick film conductive ink. This ink is usually applied by standard screen printing techniques. Each layer of circuitry is completed by screen printing conductor tracks. Also, resistor inks or high dielectric constant inks can be printed on selected layer(s) to form resistive or capacitive circuit elements. Furthermore, specially formulated high dielectric constant green tapes similar to those used in the multilayer capacitor industry can be incorporated as part of the multilayer circuitry.

After each layer of the circuit is completed, the individual layers are collated and laminated. A confined uniaxial or isostatic pressing die is used to insure precise alignment between layers. The laminate assemblies are trimmed with a hot stage cutter. Firing is typically carried out in a standard thick film conveyor belt furnace or in a box furnace with a programmed heating cycle. This method will, also, allow top and/or bottom conductors to be co-fired as part of the constrained sintered structure without the need for using a conventional release tape as the top and bottom layer, and the removal, and cleaning of the release tape after firing.

The dielectric properties of the fired tape (or film) of the present invention depend on the quantity and/or quality of total crystals and glasses present. The low temperature co-fired ceramic (LTCC) device dielectric properties also depend on the conductor used. The interaction of conductor with the dielectric tape may, in some embodiments, alter the chemistry of the dielectric portion of the device. By adjusting the heating profile and/or changing the quality and/or quantity of the filler in the tape and/or chemistry of the conductor, one skilled in the art could accomplish varying dielectric constant and/or dielectric loss values.

As used herein, the term “firing” means heating the assembly in an oxidizing atmosphere such as air to a temperature, and for a time sufficient to volatilize (burn-out) all of the organic material in the layers of the assemblage to sinter any glass, metal or dielectric material in the layers and thus densify the entire assembly.

It will be recognized by those skilled in the art that in each of the laminating steps the layers must be accurate in registration so that the vias are properly connected to the appropriate conductive path of the adjacent functional layer.

The term “functional layer” refers to the printed green tape, which has conductive, resistive or capacitive functionality. Thus, as indicated above, a typical green tape layer may have printed thereon one or more resistor circuits and/or capacitors as well as conductive circuits.

It should also be recognized that in multilayer laminates having greater than 10 layers typically require that the firing cycle may exceed 20 hours to provide adequate time for organic thermal decomposition.

The use of the composition(s) of the present invention may be used in the formation of electronic articles including multilayer circuits, in general, and to form microwave and other high frequency circuit components including but not limited to: high frequency sensors, multi-mode radar modules, telecommunications components and modules, and antennas.

These multilayer circuits require that the circuit be constructed of several layers of conductors separated by insulating dielectric layers. The insulating dielectric layer may be made up of one or more layers of the tape of the present invention. The conductive layers are interconnected between levels by electrically conductive pathways through a dielectric layer. Upon firing, the multilayer structure, made-up of dielectric and conductive layers, a composite is formed which allows for a functioning circuit (i.e. an electrically functional composite structure is formed). The composite as defined herein is a structural material composed of distinct parts resulting from the firing of the multilayer structure which results in an electrically functioning circuit.

### EXAMPLES

Tape compositions used in the examples were prepared by ball milling the fine inorganic powders and binders in a volatile solvent or mixtures thereof. To optimize the lamination, the ability to pattern circuits, the tape burnout properties and the fired microstructure development, the following volume % formulation of slip was found to provide advantages. The formulation of typical slip compositions is also shown in weight percentage, as a practical reference. The inorganic phase is assumed to have a specific density of 3.5 g/cc for glass and 4.0 g/cc for alumina and the organic vehicle is assumed to have a specific density of 1.1 g/cc. The weight % composition changes accordingly when using glass and oxides other than alumina as the specific density maybe different than those assumed in this example.

The above volume and weight % slip composition may vary dependent on the desirable quantity of the organic solvent and/or solvent blend to obtain an effective slip milling and coating performance. More specifically, the composition for the slip must include sufficient solvent to lower the viscosity to less than 10,000 centipoise; typical viscosity ranges are 1,000 to 4,000 centipoise. An example of a slip composition is provided in Table 3. Depending on the chosen slip viscosity, higher viscosity slip prolongs the dispersion stability for a longer period of time (normally several weeks). A stable dispersion of tape constituents is usually preserved in the as-coated tape.

A tape slurry or slip composition was made in accordance with the composition shown in Table 1 entitled “9K5 Tape Slurry Formulation”. The green tape composition is shown in Table 2; the glass frit used was corresponding to the composition of U.S. Pat. No. 7,687,417. This green tape corresponds to Example ID #6 in Table 3 entitled “New LTCC Compositions for Electronic substrates and High Frequency (9 GHz) Dielectric properties”.

Five additional Examples shown in Table 3 in accordance with the invention (Example ID #1, Example ID #3, Example ID #4, Example ID #5 and Example ID #7) were prepared in a similar fashion.

Example ID #2 is not an Example in accordance with the invention, it corresponds to the invention disclosed in co-pending commonly assigned Ser. No. 11/824,116.

dK values and loss tangent values for the compositions in accordance with the invention are shown in Table 3.

### Laminate Structures

In Table 4, two layers of the green tape corresponding to Example ID #1 (called “9K4 SCPLAS Tape” in the title of Table 4) were fired into four different 12-layer laminate configurations as shown in Table 4. The Example ID #1 layer locations were layer 2 and layer 11 in “SCPLAS 1”, layer 3 and layer 10 in “SCPLAS 2”, layer 4 and layer 9 in “SCPLAS 3”, and layer 6 and layer 7 in “SCPLAS 4”; with shrinkage results for the fired laminate being 1.13% for“SCPLAS 1”, 1.16% for “SCPLAS 2”, 1.10% for “SCPLAS 3”, and 1.11% for “SCPLAS 4”.

Although the location of the two layers of the green tape corresponding to Example ID #1 were in symmetrical locations relative to the top and bottom of the overall laminate, it is not anticipated that the benefit of the use of the green tapes and laminates in accordance with the invention is limited to in symmetric configurations having a 2 mil fired thickness.

Similarly, it is not anticipated that the benefit of the use of the green tapes and laminates in accordance with the invention is limited to 12 layer configurations having a 2 mil fired thickness, laminates from 6 layers up to 50 layers or more are contemplated as within the scope of the present invention.

Table 5 shows that a shrinkage of less than 2% (1.90%) can be obtained with the compositions in accordance with the invention in thicknesses of the fired structure up to 5 mils.

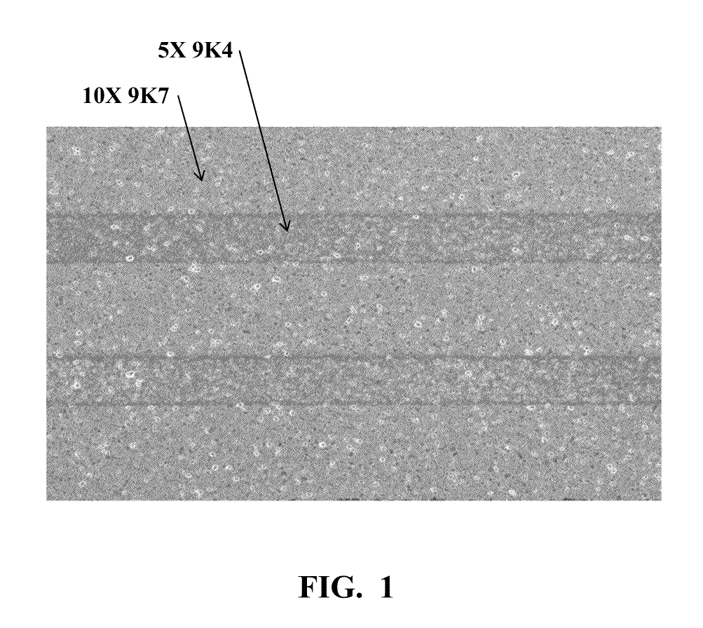

FIG. 1 shows an electron micrograph of the composite laminate in accordance with the invention and the excellent bonding and porosity between conventional DuPont 9K7 green tape and the green tape layers in accordance with the invention.

TABLE 1
9K5Tape Slurry FORMULATION

| | | |
|---|---|---|
| R3925 | 27.33% | Frit same as in EL518 |
| R0143 | 37.97% | Alumina |
| I2519 | 1.44% | Silica (surface area 8-12 meters per gram) |
| I2547 | 0.13% | Copper Oxide |
| R0263 | 0.31% | Ethylaccetate-2-ethyl hexyl acrylate copolymer: |
| | | Trade name Modaflow) |
| R0114 | 18.85% | Acylic binder Solution (35% Methyacylate plus |
| | | 65% Ethyl acctate |
| R0235 | 1.89% | Polypropylene glycol dibenzoate: Trade name |
| | | Uniplex 400 |
| TWN040 | 11.4% | Ethyl acctate |
| TWN050 | 0.62% | Isopropyl alcohol |
| Total | ~100.00% | |

| | Amt (%) |
|---|---|
| 9K5 (Slip) | |
| R3925 (Frit) | 27.326 |
| R0143 (Alumina) | 37.973 |
| I2519 (Silica) | 1.438 |
| I2537 (Cu₂O) | 0.133 |
| R0114 (Binder) | 18.855 |
| Uniplex 400 (R0235) | 1.886 |
| Modaflow 2100 (R0263) | 0.307 |
| Ethyl Acetate (TWN040) | 11.456 |
| Isopropanol (TWN050) | 0.626 |
| Total | 100.000 |
| Organic Solids (Slip) | |
| Acrylic Resin | 6.599 |
| Plasticizer | 1.886 |
| Surfactant | 0.307 |
| Total | 8.792 |
| Inorganic Solids (Slip) | |
| Frit | 27.326 |
| Alumina | 37.973 |
| Silica | 1.438 |
| Copper | 0.133 |
| Total | 66.870 |
| Total Solids (Slip) | |
| Organic Solids | 8.792 |
| Inorganic Solids | 66.870 |
| Total | 75.662 |
| Volatile Solvents (Slip) | |
| Ethyl Acetate | 23.712 |
| Isopropanol | 0.626 |
| Total | 24.338 |

TABLE 2

| | Amt (%) |
|---|---|
| 9K5 (Tape) | |
| R3925 (Frit) | 36.12 |
| R0143 (Alumina) | 50.18 |
| I2519 (Silica) | 1.90 |
| I2537 (Cu₂O) | 0.18 |
| SC035 (Arylic Resin) | 8.72 |
| Uniplex 400 (R0235) | 2.49 |
| Modaflow 2100 (R0263) | 0.41 |
| Total | 100.000 |
| Organic Solids (Tape) | |
| Organic Solids (Slip) | 8.792 |
| Tota Solids (Slip) | 75.662 |
| Organic Solids (Tape) | 11.620 |
| Inorganic Solids (Tape) | |
| Inorganic Solids (Slip) | 66.870 |
| Total Solids (Slip) | 75.662 |
| Inorganic Solids (Tape) | 88.380 |

TABLE 3
New LTCC Compositions* for Electronic Substrates
and High Frequency (9 GHz) Dielectric Properties

| | | | | | Loss |
|---|---|---|---|---|---|
| ID# | Frit | Alumina | Silica | dK | Tangent |
| 1 | 35% | 0% | 65%** | 3.8 | 0.003 |
| 2 | 50% | 0% | 50% | 4.3 | 0.003 |
| 3 | 50% | 16.5% | 33.5% | 4.8 | 0.005 |
| 4 | 50% | 25% | 25% | 5.2 | 0.002 |
| 5 | 33.3% | 33.3% | 33.3% | 5.3 | 0.003 |
| 6 | 40.9% | 56.9% | 2.2% | 5.7 | 0.002 |
| 7 | 38.8% | 56.9% | 4.3% | 5.5 | 0.002 |

*All weight % compositions are based on solids.
**Used as SPLAS (self-constraining pressure less assisted sintering) for other commercially available LTCC such as DUPONT 951, 9K7 in composite form to get a shrinkage of ~1% or less. Also SCPLAS properties could be attained with the other low dielectric loss tapes described in this invention.

TABLE 4
Effect of Location of 9K4 “SCPLAS”* Tape on Shrinkage of 9K7 System

| SCPLAS1 | | SCPLAS2 | | SCPLAS3 | | SCPLAS4 | |
|---|---|---|---|---|---|---|---|
| Layer | 9K7-PX | Layer | 9K7-PX | Layer | 9K7-PX | Layer | 9K7-PX |
| #12 | | #12 | | #12 | | #12 | |
| Layer | 9K4SCPLAS | Layer | 9K7-PX | 9K7- | 9K7-PX | Layer | 9K7-PX |
| #11 | | #11 | | PX | | #11 | |
| Layer | 9K7-PX | Layer | 9K4SCPLAS | Layer | 9K7-PX | Layer | 9K7-PX |
| #10 | | #10 | | #10 | | #10 | |
| Layer | 9K7-PX | Layer | 9K7-PX | Layer | 9K4SCPLAS | Layer | 9K7-PX |
| #09 | | #09 | | #09 | | #09 | |
| Layer | 9K7-PX | Layer | 9K7-PX | Layer | 9K7-PX | Layer | 9K7-PX |
| #08 | | #08 | | #08 | | #08 | |
| Layer | 9K7-PX | Layer | 9K7-PX | Layer | 9K7-PX | Layer | 9K4SCPLAS |
| #07 | | #07 | | #07 | | #07 | |
| Layer | 9K7-PX | Layer | 9K7-PX | Layer | 9K7-PX | Layer | 9K4SCPLAS |
| #06 | | #06 | | #06 | | #06 | |
| Layer | 9K7-PX | Layer | 9K7-PX | Layer | 9K7-PX | Layer | 9K7-PX |
| #05 | | #05 | | #05 | | #05 | |
| Layer | 9K7-PX | Layer | 9K7-PX | Layer | 9K4SCPLAS | Layer | 9K7-PX |
| #04 | | #04 | | #04 | | #04 | |
| Layer | 9K7-PX | Layer | 9K4SCPLAS | Layer | 9K7-PX | Layer | 9K7-PX |
| #03 | | #03 | | #03 | | #03 | |
| Layer | 9K4SCPLAS | Layer | 9K7-PX | Layer | 9K7-PX | Layer | 9K7-PX |
| #02 | | #02 | | #02 | | #02 | |
| Layer | 9K7-PX | Layer | 9K7-PX | Layer | 9K7-PX | Layer | 9K7-PX |
| #01 | | #01 | | #01 | | #01 | |

Composite Shrinkage: 10 layer 10X 9K7 + 2 layer 9K4 SCPLAS tape

| | |
|---|---|
| SCPLAS #1: 1.13% | Stdev. 0.05 |
| SCPLAS #2: 1.16% | Stdev. 0.04 |
| SCPLAS #3: 1.10% | Stdev. 0.06 |
| SCPLAS #4: 1.11% | Stdev. 0.03 |

*9K7 SCPLAS listed above has the same composition as 9K4 SCPLAS listed in Table 5.
scPLAS tape thickness is 5 mil.

TABLE 5
Effect of 9K4 “SCPLAS”* Tape Thickness on 9K7 Shrinkage

| | |
|---|---|
| 2 mil SCPLAS | 5 mil SCPLAS |

| | | | |
|---|---|---|---|
| Layer #12 | 9K7-PX | Layer #12 | 9K7-PX |
| Layer #11 | 9K7-PX | Layer #11 | 9K7-PX |
| Layer #10 | 9K4SCPLAS | Layer #10 | 9K4SCPLAS |
| Layer #09 | 9K7-PX | Layer #09 | 9K7-PX |
| Layer #08 | 9K7-PX | Layer #08 | 9K7-PX |
| Layer #07 | 9K7-PX | Layer #07 | 9K7-PX |
| Layer #06 | 9K7-PX | Layer #06 | 9K7-PX |
| Layer #05 | 9K7-PX | Layer #05 | 9K7-PX |
| Layer #04 | 9K7-PX | Layer #04 | 9K7-PX |
| Layer #03 | 9K4SCPLAS | Layer #03 | 9K4SCPLAS |
| Layer #02 | 9K7-PX | Layer #02 | 9K7-PX |
| Layer #01 | 9K7-PX | Layer #01 | 9K7-PX |
| Shrinkage (%) | 0.68 | Shrinkage (%) | 1.90 |
| St. Dev. | 0.08 | St. Dev. | 0.06 |

What is claimed is:

1. A green tape composition comprising:
(a) 22-35% a glass composition having a remnant glass component;
(b) 32-45% inorganic filler having particles; and
(c) 33% polymeric binder system,
wherein the wetting angle of the remnant glass component is sufficient to cover the particles of the inorganic filler.

2. The green tape composition of claim 1, wherein the glass composition is selected from the phosphor-boro-silicate glass network group comprising major glass net-work modifying ions.

3. The green tape composition of claim 2, wherein the inorganic filler having particles is selected from the refractory oxide group comprising silicon dioxide, aluminum oxide or combinations thereof.

4. The green tape composition of claim 3, wherein the polymeric binder system comprises organic resins, wetting agents and residual organic solvents.

5. The green tape composition of claim 4 comprising:
25-40 weight % glass composition, based on a total weight of (a) and (b) based on mole percent, (i) 46-57.96% B₂O₃, (ii) a glass network former selected from the group consisting of 0.5-8.5% P₂O₅, 1.72-5.00% SiO₂, and mixtures of P₂O₅ and SiO₂ wherein the combined mole % of said mixture of P₂O₅ and SiO₂ is 3.44-8.39%, (iii) 20-50% CaO, (iv) 2-15% Ln₂O₃ where Ln is selected from the group consisting of rare earth elements and mixtures thereof; (v) 0-6% Ml₂O where Ml is selected from the group consisting of alkali elements; and (vi) 0-10% Al₂O₃, wherein said glass composition is a ceramic-filled, devitrified glass composition, wherein said glass composition flows prior to crystallization;
the inorganic filler consists essentially of 60-75 weight % silica refractory oxide, based on a total weight of (a) and (b), both (a) and (b) dispersed in a solution of organic polymeric binder,
wherein said green tape, after firing, has a dK between 3.5 and 4.0 and a loss tangent of less than 0.004.

6. The green tape composition of claim 4 comprising, based on solids:
30-55 weight % glass composition, based on a total weight of (a) and (b) comprising, based on mole percent, (i) 46-57.96% B₂O₃, (ii) a glass network former selected from the group consisting of
0.5-8.5% P₂O₅, 1.72-5.00% SiO₂, and mixtures of P₂O₅ and SiO₂ wherein the combined mole % of said mixture of P₂O₅ and SiO₂ is 3.44-8.39%, (iii) 20-50% CaO, (iv) 2-15% Ln₂O₃ where Ln is selected from the group consisting of rare earth elements and mixtures thereof; (v) 0-6% Ml₂O where Ml is selected from the group consisting of alkali elements; and (vi) 0-10% Al₂O₃, wherein said glass composition is a ceramic-filled, devitrified glass composition, wherein said glass composition flows prior to crystallization;
the inorganic filler consists essentially of 45-70 weight refractory oxide, based on a total weight of (a) and (b), comprising silica and alumina in a SiO₂:Al₂O₃ weight ratio from between about 2:1 to about 1:1, both (a) and (b) dispersed in a solution of organic polymeric binder,
wherein said green tape composition, after firing, has a dK between 4.5 and 5.4 and a loss tangent of between 0.003 and 0.005.

7. The green tape composition of claim 4 comprising, based on solids:
38-42 weight % glass composition, based on a total weight of (a) and (b), comprising, based on mole percent, (i) 46-57.96% B₂O₃, (ii) a glass network former selected from the group consisting of 0.5-8.5% P₂O₅, 1.72-5.00% SiO₂, and mixtures of P₂O₅ and v wherein the combined mole % of said mixture of P₂O₅ and SiO₂ is 3.44-8.39%, (iii) 20-50% CaO, (iv) 2-15% Ln₂O₃ where Ln is selected from the group consisting of rare earth elements and mixtures thereof; (v) 0-6% Ml₂O where Ml is selected from the group consisting of alkali elements; and (vi) 0-10% Al₂O₃, wherein said glass composition is a ceramic-filled, devitrified glass composition, wherein said glass composition flows prior to crystallization;
the inorganic filler consisting essentially of 58-62 weight % refractory oxide, based on a total weight of (a) and (b), comprising silica and alumina, wherein said silica is less than about 5.0 wt % and more than about 2.0 wt %, based on a total weight of (a) and (b), both (a) and (b) dispersed in a solution of organic polymeric binder,
wherein said green tape composition, after firing, has a dK greater than 5.4 and less than 6.0 and a loss tangent of less than 0.003.

8. The green tape composition of claim 4 comprising, based on solids:
25-40 weight % glass composition, based on a total weight of (a) and (b) comprising, based on mole percent, 50-67% B₂O₃; 20-50% CaO; 2-15% Ln₂O₃ where Ln is selected from the group consisting of rare earth elements and mixtures thereof; 0-6% Ml₂O where Ml is selected from the group consisting of alkali elements; and 0-10% Al₂O₃, with the proviso that the composition is water millable;
60-75 weight % silica refractory oxide, based on a total weight of (a) and (b), both (a) and (b) dispersed in a solution of organic polymeric binder,
wherein said green tape composition, after firing, has a dK between 3.5 and 4.0 and a loss tangent of less than 0.004.

9. The green tape composition of claim 4 comprising, based on solids:
30-55 weight % glass composition, based on a total weight of (a) and (b), comprising, based on mole percent, 50-67% B₂O₃; 20-50% CaO; 2-15% Ln₂O₃ where Ln is selected from the group consisting of rare earth elements and mixtures thereof; 0-6% v where Ml is selected from the group consisting of alkali elements; and 0-10% Al₂O₃, with the proviso that the composition is water millable;
45-70 weight % refractory oxide, based on a total weight of (a) and (b), comprising silica and alumina in a SiO₂:Al₂O₃ weight ratio from between about 2:1 to about 1:1, both (a) and (b) dispersed in a solution of organic polymeric binder,
wherein said green tape composition, after firing, has a dK between 4.5 and 5.4 and a loss tangent of between 0.003 and 0.005.

10. The green tape composition of claim 4 comprising, based on solids:
38-42 weight % glass composition, based on a total weight of (a) and (b), based on mole percent, 50-67% B₂O₃; 20-50% CaO; 2-15% Ln₂O₃ where Ln is selected from the group consisting of rare earth elements and mixtures thereof; 0-6% Ml₂O where Ml is selected from the group consisting of alkali elements; and 0-10% Al₂O₃, with the proviso that the composition is water millable;
58-62 weight % refractory oxide, based on a total weight of (a) and (b), comprising silica and alumina, wherein said silica is less than about 5.0 wt % and more than about 2.0 wt %, based on a total weight of (a) and (b), both (a) and (b) dispersed in a solution of organic polymeric binder,
wherein said green tape composition, after firing, has a dK greater than 5.4 and less than 6.0 and a loss tangent of less than 0.003.

11. A fired green tape according to any of claims 5 to 10.

12. A fired multilayer laminate structure comprising (a) at least 2 layers fired green tape according to claim 11 and (b) at least 4 layers of fired green tape of another composition and having a dK greater than about 6 and also having a shrinkage, when measured as a single fired green tape layer of at least about 7%, wherein said fired multilayer laminate structure has an overall shrinkage between 1.00% and 1.25%.

13. A multilayer laminate structure according to claim 12 comprising at least ten total layers (a) and (b).

14. A multilayer laminate structure according to claim 12 comprising at least twenty total layers (a) and (b).

15. A multilayer laminate structure according to claim 12 wherein said layers (a) and (b) are in a symmetrical configuration.

16. A multilayer laminate structure according to claim 12 having a thickness of at least about 2 millimeters.

17. A multilayer laminate structure according to claim 12 having a thickness of at least about 5 millimeters.
